(19) United States
(12) Patent Application Publication
(10) Pub. No.: US 2019/0050872 A1
(43) Pub. Date: Feb. 14, 2019

(54) USER INTEREST AND RELATIONSHIP DETERMINATION

(71) Applicants: Xiao-Feng YU, Beijing (CN); Jun-Qing XIE, Beijing (CN); Meng GUO, Shanghai (CN); ENTIT SOFTWARE LLC, Sanford, NC (US)

(72) Inventors: Xiaofeng Yu, Beijing (CN); Jun Qing Xie, Beijing (CN); Meng Guo, Shanghai (CN)

(21) Appl. No.: 16/074,631

(22) PCT Filed: Feb. 5, 2016
(86) PCT No.: PCT/CN2016/073690

§ 371 Date: Aug. 1, 2018

(51) Int. Cl. G06Q 30/02; G06F 17/30; G06Q 50/00; G06N 7/00

(52) U.S. Cl. CPC G06Q 30/0201; G06N 7/005; G06Q 50/01; G06F 17/30604

(57) ABSTRACT

In one example in accordance with the present disclosure, a method for user interest and relationship determination may include distributing a first and a second set of pairs to a plurality of data nodes. The method may also include calculating, on a first data node, a probability of a user's interest in a product based on an observable factor and a latent factor and calculating, on second data node, a probability of a likelihood of a relationship between the user and a second user, based on an observable factor and a latent factor. The method may also include determining a most likely interest and a most likely relationship of the user and predicting a potential interest of the user based on the most likely interest and the most likely relationship.

### BACKGROUND

The advent of social networking sites on the Internet has led an unprecedented number of users registered with social networking sites to engage in interesting user activities such as commenting on, liking, and re-sharing content as well as interacting with each other to share thoughts. The exponential growth of information repositories and the diversity of users on these social networking sites provide great challenges.

### BRIEF DESCRIPTION OF THE DRAWINGS

The following detailed description references the drawings, wherein:

FIG. 1 is a block diagram of an example system for user interest and relationship determination;

FIG. 2 is a flowchart of an example method for user interest and relationship determination;

FIG. 3 is a block diagram of an example system for user interest and relationship determination; and

FIG. 4 is a block diagram of an example system for user interest and relationship determination.

### DETAILED DESCRIPTION

A user of a social network may have certain interests, such as products, events, items, etc. as well as connections to other people. These connections may be formally established though a direct connection or informally established. An informally established connection may between users that are connected through a third user, connected through a similar interest, connected though an action such as commenting on the same page, etc. A mutual bidirectional interaction is an action by the user that is influenced by both the user's individual interests and the user's connections.

For example, a first user may make a decision with respect to a first product based on her own interest in the first product and/or based on a second user's opinion. The opinion of the second user may be expressed as a comment on the social network, a message from the second user to the first user, an endorsement of the second user (a like, a thumbs up, etc.), etc. The first and second user may also be connected on the social network. Accordingly, the connection between the first user and the second user may be a mixture of their prior impressions to each other and their similar interests in product(s), such as the first product. The widespread social phenomenon of homophily suggests that socially acquainted users tend to behave similarly. The homophily social effect is also called the theory of “birds of a feather flock together”—people tend to follow the behaviors of their friends, and people tend to create relationships with other people who are already similar to them.

Determining the likelihood of a connection between the first user and the second user may be helpful in discovering similar interests for product recommendation. Moreover, if two users have similar interests, there may be a high likelihood of a connection between them. With the dramatically rapid growth and great success of many large-scale online social networking services, social media establishes connections between companies and users. Tracking the data created by users on social networks may allow companies to gain feedback and insight in understanding the users' interests.

Recommending products to consumers could not only enhance revenue and profit, but also help commercial companies to understand consumers' interests and market demand. Moreover, discovering potentially valuable consumers though the connections of users on social media can aid companies in better decision making, and benefit product recommendation ultimately. The system for user interest and relationship determination leverages the bidirectional interactions between users' preferences and user-user connections in big social media and performs simultaneous user interest recommendation and connection discovery.

An example method for user interest and relationship determination may include distributing a first set of pairs and a second set of pairs to a plurality of data nodes, wherein each pair in the first set of pairs is of a user of a social network and a product on the social network and each pair in the second set of pairs defines a connection between users on the social network. The method may also include calculating, on a first data node belonging to the plurality, a first probability of a first user's interest in a first product based on a first observable factor and a first latent factor, wherein the first user and the first product belong to a first pair from the first set of pairs. The method may also include calculating, on a second data node, a second probability of a likelihood of a relationship between the first user and a second user of the social network, based on a second observable factor and a second latent factor, wherein the first user and the second user belong to a second pair from the second set of pairs. The method may also include determining, based on the first probability and the second probability, a most likely interest of the first user and a most likely relationship of the first user and predicting a potential interest of the first user based on the most likely interest and the most likely relationship.

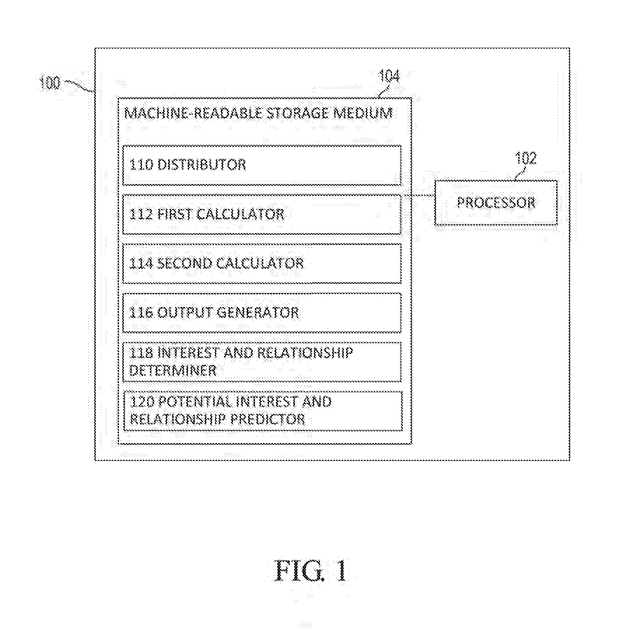

FIG. 1 is a block diagram of example system 100 for user interest and relationship determination. System 100 may include a processor 102 and a memory 104 that may be coupled to each other through a communication link (e.g., a bus). Processor 102 may include a Central Processing Unit (CPU) or another suitable hardware processor. In some examples, memory 104 stores machine readable instructions executed by processor 102 for system 100. Memory 104 may include any suitable combination of volatile and/or non-volatile memory, such as combinations of Random Access Memory (RAM), Read-Only Memory (ROM), flash memory, and/or other suitable memory. Memory 104 may also include a random access non-volatile memory that can retain content when the power is off.

Memory 104 stores instructions to be executed by processor 102 including instructions for and/or other components. According to various implementations, user interest and relationship determination system 100 may be implemented in hardware and/or a combination of hardware and programming that configures hardware. Furthermore, in FIG. 1 and other FIGS. described herein, different numbers of components or entities than depicted may be used.

Processor 102 may execute instructions of distributor 110 to distribute a first set of pairs and a second set of pairs to a plurality of data nodes. A data node stores data in the file system. The set of pairs includes any number of pairs. Each pair in the first set of pairs may be of a user of a social network and an interest of the user on the social network. Interests may include products, events, items, etc. Each pair in the second set of pairs may define a connection between users on the social network. The connection may be a direct connection or an indirect connection. An indirect connection may be between users that are connected through a third user, connected through a similar interest, connected though activities, such as commenting on the same page, etc.

The first pair and the second pair may be used as a first input key and a second input key, respectively, for a map function. A first observable factor and a first latent factor may be used as values for the first input key. A second observable factor and a second latent factor may be used as values for the second input key.

Distributor 110 may distribute the first and second set of pairs using a distributed data processing framework. Distributor 110 may distribute each pair in the first set of pairs and the second pairs to a plurality of data nodes. Each data node in the plurality of data nodes may processes a pair. One example framework is the Apache™ Hadoop® framework that allows for the scalable parallel and distributed computing of large data sets across clusters of computers using programming models such as MapReduce. Hadoop® consists of two layers: a data storage layer Hadoop Distributed File System and a data processing layer called MapReduce framework. The MapReduce framework adopts a master-slave architecture which consists of one master node and multiple slave nodes in the clusters. The master node is generally served as JobTracker and each slave node is generally served as TaskTracker.

Distributor 110 may also use a MapReduce programming technique. MapReduce is based on two functions: Map and Reduce. The Map function applies a user-defined function to each key-value pair<input key; input value>in the input data. The result of the map function may be a list of intermediate key-value pairs, sorted and grouped by key (i.e. list[<map key; map value>]), and passed as input to the Reduce function. The Reduce function applies a second user-defined function to the intermediate key and its associated values (i.e. <map key; list [map value]>), and produces the final aggregated result [<output key; output value>].

MapReduce may utilize a distributed file system from which the Map instances retrieve the input. An example distributed file system is the Hadoop Distributed File System (HDFS). HDFS is a chunk-based distributed file system that supports fault-tolerance by data partitioning and replication.

Processor 102 may execute instructions of first calculator 112 calculate, on a first data node, a first probability of a first user's interest in a first interest based on a first observable factor and a first latent factor. An observable factor may be historical information corresponding to a user. For example, observable factors may include a user's registered data, user's behavioral data, etc. A latent factor is information corresponding to user interactions between connections to interests. Latent factors are usually implicit and/or hidden and are thus unobservable. The first user and the first product may belong to a first pair from the first set of pairs (e.g. as discussed in reference to distributor 110). The first pair may be used as an input key for a map function. The first observable factor and the first latent factor may be used as values for the first input key. For example, the map key for the first data node may be the user-interest pair <i; j>. The value for the map key may be the product of observable and latent factors φφₕ for <i; j>.

Processor 102 may execute instructions of second calculator 114 to calculate, on a second data node, a second probability of a likelihood of a relationship between the first user and a second user based on a second observable factor and a second latent factor. The first user and the second user belong to a second pair from the second set of pairs (e.g. as discussed in reference to distributor 110). The second pair may be used as an input key for a map function. The second observable factor and the second latent factor may be used as values for the second input key. For example, the map key may be the product of user-user pair <i; k>. The value for the map key may be the product of product of observable and latent factors φ′φ′ₕ for <i; k>.

Processor 102 may execute instructions of output generator 116 to generate, based on the first probability and the second probability, a triplet. The triplet may be the output key of a map function. The value of the output key may be a product of probability distribution Yᵢⱼ Sᵢₖ. The triplet may be a user-interest-user triplet <i, j, k>. The triplet may include two users from the social network and a product that at least one of the two users has expressed interest in on the social network. Output generator 116 may determine a probability distribution of the first user's interest in the first product and the relationship between the first user and the second user.

Output generator 116 may incorporate a mutual latent random graphs (MLRGs) that incorporates the interactions between users' interests and users' connections. The MLRG may incorporate shared latent factors and coupled models to encode users' interests Yᵢⱼ (user i's interest in product j) and user-user connections Sᵢₖ (connection between user i and user k). Output generator 116 may express the probability distribution of Yᵢⱼ as Yᵢⱼ˜p(φφₕ,θ), with θ representing any corresponding parameters. The expression may include an assumption that certain observable factors (φ) exist and certain latent factors (φₕ) exist. Output generator 116 may express the probability distribution of Sᵢₖ as Sᵢₖ˜p(φ′φ′ₕ,Ω), with Ω representing any corresponding parameters. The expression may include an assumption that certain observable factors (φ′) exist and certain latent factors (φ′ₕ) exist. Importantly, both φₕ and φ′ₕ may capture bidirectional interactions between interests and connections.

The four factors φ, φₕ, φ′, φ′ₕ can be instantiated in different ways. Each factor may be defined as the exponential family of an inner product over sufficient statistics (feature functions) and corresponding parameters. Each factor may be a clique template whose parameters are tied. More specifically, the factors may be defined as:

φ=exp{Σ′α̅f} Equation (1)

φₕ=exp{Σβ̅g} Equation (2)

φ′=exp{Σγ̅h} Equation (3)

φ′ₕ=exp{Σδ̅q} Equation (4)

α̅, β̅, γ̅, and δ̅ may be real-valued weighting vectors and f, g, h and q may be corresponding vectors of sufficient statistics (feature functions).

In other words, a map function may involve calculating probability distributions on data nodes in parallel (e.g. as discussed as discussed in reference to first calculator 112 and second calculator 114) and generating triplet product of probability distribution Yᵢⱼ Sᵢₖ (as discussed in reference to output generator 116). Each data node may calculate the probability distribution Yᵢⱼ˜p(φφₕ, θ) and the probability distribution Sⱼₖ˜p(φ′φ′ₕ, Ω). This process be repeated until a convergence occurs.

The probability distribution Yᵢⱼ may be calculated as:

$${Y}_{ij} \sim p ( {ϕϕ}_{h} , θ ) = \frac{1}{{z}_{1}} exp \{ \sum \overline{α} f + \sum \overline{β} g \} \qquad Equation ( 5 )$$

Similarly, the probability distribution may be calculated as:

$${S}_{jk} \sim p ( {ϕ}^{′} {ϕ}_{h}^{′} , Ω ) = \frac{1}{{z}_{2}} exp \{ \sum \overline{ϒ} h + \sum \overline{δ} q \} \qquad Equation ( 6 )$$

In equation (5) above, θ={α̅, β̅} may be the parameter vector for Yᵢⱼ, and in equation (6), Ω={γ̅, δ̅} may be the parameter vector for Sᵢₖ. Both Z1 and Z2 are the normalization factors for Yᵢⱼ and Sᵢₖ, respectively. Thus the joint probability distribution of the mutual latent random graphs (MLRGs) can be formally defined as expressed in equation (7) below, where Z=Z1·Z2 is the normalization factor of MLRGs.

$$( {Y}_{ij} , {S}_{jk} ) \sim {Y}_{ij} \cdot {S}_{jk} \sim p ( {ϕϕ}_{h} , θ ) \cdot p ( {ϕ}^{′} {ϕ}_{h}^{′} , Ω ) = \frac{1}{Z} exp \{ \sum \overline{α} f + \sum \overline{β} g + \sum \overline{ϒ} h + \sum \overline{δ} q \} \qquad Equation ( 7 )$$

Processor 102 may execute instructions of interest and relationship determiner 118 to determine, based on the first probability and the second probability, a most likely interest of the first user and/or a most likely relationship of the first user. A triplet (e.g. as discussed in reference to output generator 116) may be used as an input key for a reduce function. A probability distribution and/or a product of probability distribution Yᵢⱼ Sᵢₖ may be used as values for the input key for the reduce function. Interest and relationship determiner 118 may merge a result of processing by the plurality of data nodes (e.g. as discussed in reference to distributor 110) using the triplet (e.g. as discussed in reference to output generator 116) as a key so that all values using the same triplet are grouped together.

Interest and relationship determiner 118 may determine the most likely interest of the first user and the most likely relationship of the first user as an output of the reduce function. An output key for the output of the reduce function may be an objective function [symbol] (θ,Ω). The value for the output key may be updated and optimized parameters θ and Ω. Interest and relationship determiner 118 may maximize an objective function corresponding to the triplet. A first parameter of the objective function may correspond to the most likely interest of the first user and a second parameter of the objective function may correspond to the most likely relationship of the first user. The objective function may be maximized using a data mining algorithm, such as stochastic gradient descent.

A data mining algorithm (such as a stochastic gradient descent) may be performed with respect to θ with Ω fixed and Ω may be updated. A data mining algorithm such as a stochastic gradient descent) may be performed with respect to Ω with θ fixed and θ may be updated. This process may be repeated until a convergence occurs.

Stochastic gradient descent (SGD) may loop over all the observations and update the parameters θ and Ω by moving in the direction defined by negative gradient. Each data node (e.g. as discussed in reference to first calculator 112 and second calculator 114), may compute and optimize with respect to either Yᵢⱼ or Sᵢₖ in the Map phase, and the results may be combined in a reduce phase to optimize both parameters θ and Ω globally. After distributed SCD learning, the optimized parameters can be obtained and joint recommendation of interest and friendship can be achieved by computing the most likely Yᵢⱼ or Sᵢₖ, respectively.

In other words, the reduce function may include calculating the objective function [symbol] (θ,Ω) and updating all parameters on a master node. The master node may calculate and maximize the objective function [symbol] (θ,Ω). The master node may update and optimize the parameters (θ,Ω) such that (θ*, Ω*)=arg max [symbol] (θ,Ω).

After stochastic gradient descent (SGD) for distributed MapReduce learning, an optimized θ and Ω of MLRGs may be obtained. The optimized parameters θ and Ω may be used to discover user interest and infer user-user friendship. More specifically, given the testing social media data, the inference may find the most likely types of user interest and corresponding user-user relationship labels that have the maximum posterior probability. This can be accomplished by performing the model inference of MLRGs. Performing the model inference may include predicting the labels of user interest and user-user friendship finding the maximum a posterior (MAP) user interest labeling assignment and corresponding user-user friendship labeling assignment that have the largest marginal probability according to equations (5) and (6) described above.

The overall MapReduce processing of the user interest and relationship determination system may be summarized as follows. Each processing job in may be broken down to as many Map tasks as input data blocks and one or more Reduce tasks. A master node may select idle workers (data nodes) and may assigns each data node a map or a reduce task according to the stage. Before starting the Map task, an input file may be loaded on the distributed file system. At loading, the file may partitioned into multiple data blocks of the same size. One example size of a data block may be 64 MB. Each block may be triplicated for fault-tolerance. Each block may also be assigned to a mapper, a worker which is assigned a map task, and the mapper may applies a map function (Map()) to each record in the data block.

The intermediate outputs produced by the mappers may be sorted locally for grouping key-value pairs sharing the same key. After local sort, a combine function (Combine()) may be applied to perform pre-aggregation on the grouped key-value pairs so that the communication cost taken to transfer all the intermediate outputs to reducers is minimized. Then the mapped outputs may be stored in local disks of the mappers, partitioned into R, where R is the number of Reduce tasks in the MR job. This partitioning may be done by a hash function e.g. hash(key) mod R.

When all Map tasks are completed, the MapReduce scheduler may assign Reduce tasks to workers. The intermediate results may be shuffled and assigned to reducers via HTTPS protocol. Since all mapped outputs may already be partitioned and stored in local disks, each reducer may perform the shuffling by simply pulling its partition of the mapped outputs from mappers. Put another way, each record of the mapped outputs may be assigned to only a single reducer by one-to-one shuffling strategy. Note that this data transfer may be performed by reducers' pulling intermediate results. A reducer may read the intermediate results and merge them by the intermediate keys, i.e. map key, so that all values of the same key are grouped together. The grouping may be done by external merge-sort. Each reducer may also apply a reduce function (Reduce()) to the intermediate values for each map key it encounters. The output of reducers may be stored and triplicated in the file system.

The number of Map tasks may not depend on the number of nodes, but may be based on the number of input blocks. Each block may be assigned to a single Map task. However, all Map tasks do not need to be executed simultaneously and neither do all Reduce tasks. The MapReduce framework may executes tasks based on runtime scheduling scheme. In other words, MapReduce may not build any execution plan that specifies which tasks will run on which nodes before execution.

With the runtime scheduling, MapReduce may achieve fault tolerance by detecting failures and reassigning tasks of failed nodes to other healthy nodes in the cluster. Nodes which have completed their tasks may be assigned another input block. This scheme naturally achieves load balancing in that faster nodes will process more input chunks and slower nodes process less inputs in the next wave of execution. Furthermore, a MapReduce scheduler may utilize a speculative and redundant execution. Tasks on straggling nodes may be redundantly executed on other idle nodes that have finished their assigned tasks, although the tasks are not guaranteed to end earlier on the new assigned nodes than on the straggling nodes. Map and Reduce tasks may be executed with no communication between other tasks.

Thus, there is no contention arisen by synchronization and no communication cost between tasks during a MR job execution.

An example architecture for the user interest and relationship determination system 100 may exploit Extraction-Transformation-Loading (ETL) technology for heterogeneous (structured and unstructured) big social data to the data storage layer. An example storage layer may include a relational database management system (RDBMS), a NoSQL database management system and logs of social media data. The architecture may also include server-based tool designed to transfer data between Hadoop and relational databases. Example tools may include the Sqoop2™ system (from Cloudera™), MongoDB connector™ (from MongoDB, Inc.) and Flume4™ (from Apache™) to transfer the RDBMS, NoSQL and Log data to the joint recommender layer for distributed analysis respectively. Sqoop2 is a tool designed for transferring bulk data between Hadoop and structured data stores such as relational databases. The MongoDB connector™ is a plugin for Hadoop™ that provides the ability to use MongoDB™ as an input source and/or an output destination. Flume™ is a distributed, reliable, and available service for efficiently collecting, aggregating, and moving large amounts of log data. It has a flexible architecture based on streaming data flows. It is robust and fault tolerant with tunable reliability mechanisms and many failover and recovery mechanisms. It uses a simple extensible data model that allows for online analytic application. The joint recommender layer may consists of a data model storing rich social information and a joint recommender engine for MLRGs and advanced MapReduce learning.

Processor 102 may execute instructions of potential interest and relationship predictor 120 to predict a potential interest of the first user and/or a potential relationship between the first user and a user of the social network based on the most likely interest and the most likely relationship.

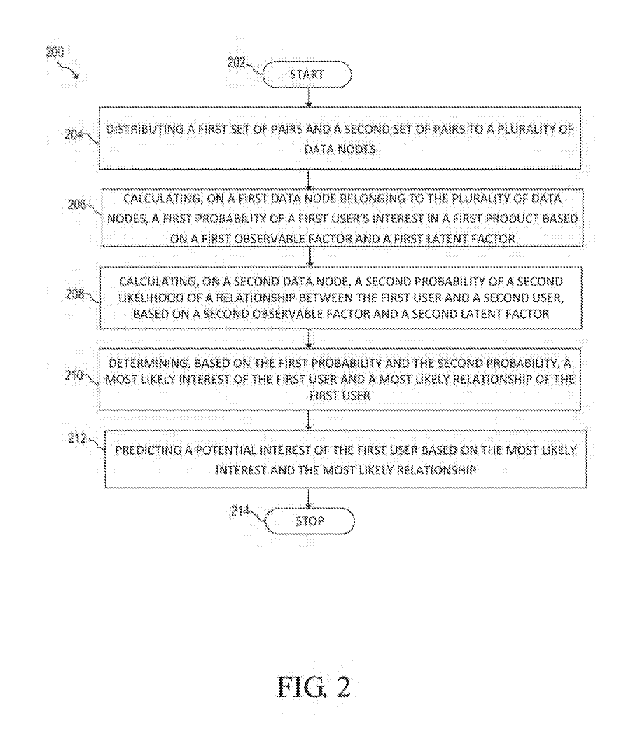

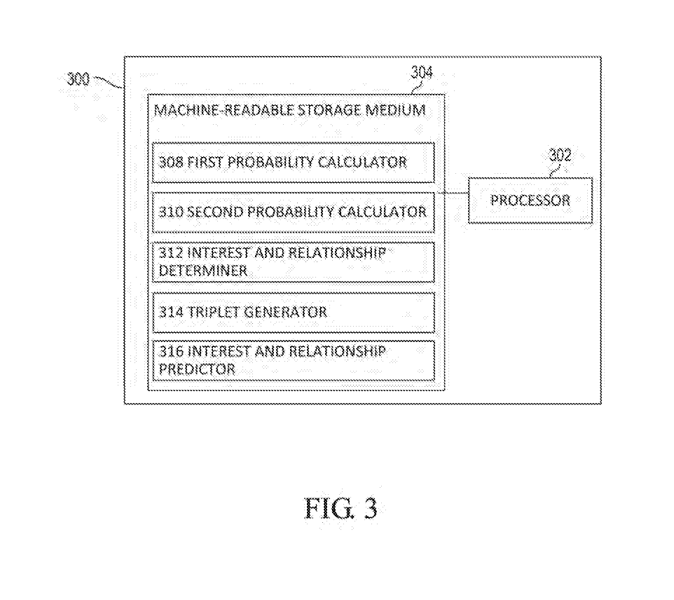

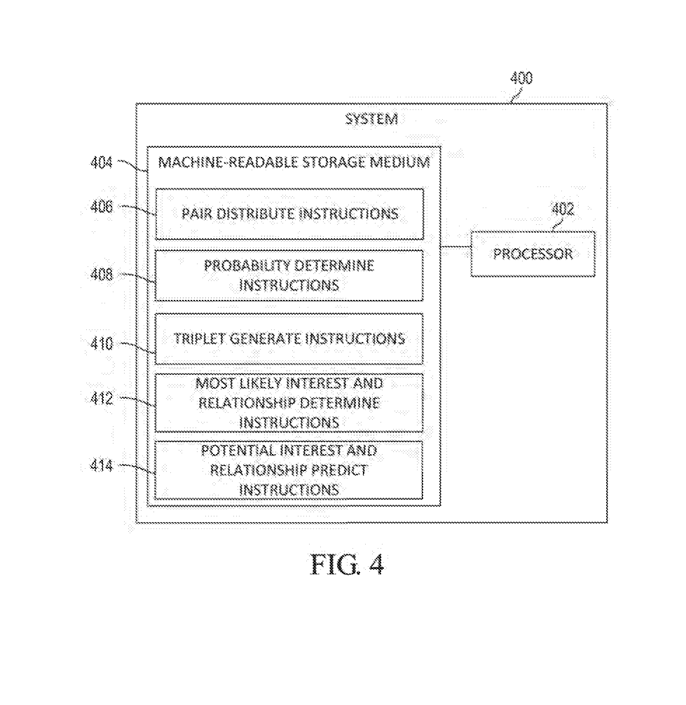

FIG. 2 is a flowchart of an example method 200 for user interest and relationship determination. Method 200 may be described below as being executed or performed by a system, for example, system 100 of FIG. 1, system 300 of FIG. 3 or system 400 of FIG. 4. Other suitable systems and/or computing devices may be used as well. Method 200 may be implemented in the form of executable instructions stored on at least one machine-readable storage medium of the system and executed by at least one processor of the system. The processor include a Central Processing Unit (CPU) or another suitable hardware processor. The machine-readable storage medium may be non-transitory. Method 280 may be implemented in the form of electronic circuitry (e.g., hardware). At least one block of method 200 may be executed substantially concurrently or in a different order than shown in FIG. 2. Method 200 may include more or less blocks than are shown in FIG. 2. Some the blocks of method 200 may, at certain times, be ongoing and/or may repeat.

Method 200 may start at block 202 and continue to block 204, where the method may include distributing a first set of pairs and a second set of pairs to a plurality of data nodes. Each pair in the flat set of pairs may be of a user of a social network and a product on the social network. Each pair in the second set of pairs may define a connection between users on the social network. A first pair from the first set of pairs and a second pair from the second set of pairs may be used as a first input key and a second input key, respectively, for a map function. A first observable factor and a first latent factor may be used as values for the first input key. A second observable factor and a second latent factor may be used as values for the second input key. At block 206, the method may include calculating, on a first data node belonging to the plurality of data nodes, a first probability of a first user's interest in a first product based on a first observable factor and a first latent factor. The first user and the first product belong to a first pair from the first set of pairs.

At block 208, the method may include calculating, on a second data node, a second probability of a likelihood of a relationship between the first user and a second user, based on a second observable factor and a second latent factor. The first user and the second user belong to a second pair from the second set of pairs. At block 210, the method may include determining, based on the first probability and the second probability, a most likely interest of the first user and a most likely relationship of the first user. At block 212, the method may include predicting a potential interest of the first user based on the most likely interest and the most likely relationship. The method may also include predicating a potential relationship between the first user and another user of the social network based on the most likely interest and the most likely relationship. Method 200 may eventually continue to block 214, where method 200 may stop.

FIG. 3 is a block diagram of an example system 300 for user interest and relationship determination. System 300 may include a processor 302 and a memory 304 that may be coupled to each other through a communication link (e.g., a bus). Processor 302 may include a Central Processing Unit (CPU) or another suitable hardware processor. In some examples, memory 304 stores machine readable instructions executed by processor 302 for operating system 300. Memory 304 may include any suitable combination of volatile and/or non-volatile memory, such as combinations of Random Access Memory (RAM), Read-Only Memory (ROM), flash memory, and/or other suitable memory.

Memory 304 stores instructions to be executed by processor 302 including instructions for a first probability calculator 308, a second probability calculator 310, an interest and relationship determiner 312, a triplet generator 314 and an interest and relationship predictor 316. The components of system 300 may be implemented in the form of executable instructions stored on at least one machine-readable storage medium of system 300 and executed by at least one processor of system 300. The machine-readable storage medium may be non-transitory. Each of the components of system 300 may be implemented in the form of at least one hardware device including electronic circuitry for implementing the functionality of the component.

Processor 302 may execute instructions of first probability calculator 308 to calculate, on a first data node, a first probability of a first user's interest in a first product based on a first observable factor and a first latent factor. The first user and the first product may be used as a first input key. The first user and the second user may be used as a second input key for a map function. A first observable factor and a first latent factor may be used as values for the first input key. A second observable factor and a second latent factor are used as values for the second input key. Processor 302 may execute instructions of second probability calculator 310 to calculate, on a second data node, a second probability of a likelihood of a relationship between the first user and a second user based on a second observable factor and a second latent factor. Processor 302 may execute instructions of interest and relationship determiner 312 to determine, based on the first probability and the second probability, a most likely interest of the first user and a most likely relationship of the first user.

Processor 302 may execute instructions of triplet generator 314 to generate, based on the first probability and the second probability, a triplet including two users from the social network and a product that at least one of the two users has expressed interest in on the social network. Processor 302 may execute instructions of an interest and relationship predictor 316 predict a potential interest of the first user and/or a potential relationship of the first user to another user on the social network based on the most likely interest and the most likely relationship.

FIG. 4 is a block diagram of an example system 400 for user interest and relationship determination. System 400 may be similar to system 100 of FIG. 1, for example. In the example illustrated in FIG. 4, system 400 includes a processor 402 and a machine-readable storage medium 404. Although the following descriptions refer to a single processor and a single machine-readable storage medium, the descriptions may also apply to a system with multiple processors and multiple machine-readable storage mediums. In such examples, the instructions may be distributed (e.g., stored) across multiple machine-readable storage mediums and the instructions may be distributed (e.g., executed by) across multiple processors.

Processor 402 may be at least one central processing unit (CPU), microprocessor, and/or other hardware devices suitable for retrieval and execution of instructions stored in machine-readable storage medium 404. In the example illustrated in FIG. 5, processor 402 may fetch, decode, and execute instructions 406, 408, 410, 412 and 414 to perform user interest and relationship determination. Processor 402 may include at least one electronic circuit comprising a number of electronic components for performing the functionality of at least one of the instructions in machine-readable storage medium 404. With respect to the executable instruction representations (e.g., boxes) described and shown herein, it should be understood that part or all of the executable instructions and/or electronic circuits included within one box may be included in a different box shown in the figures or in a different box not shown.

Machine-readable storage medium 404 may be any electronic, magnetic, optical, or other physical storage device that stores executable instructions. Thus, machine-readable storage medium 404 may be, for example, Random Access Memory (RAM), an Electically-Erasable Programmable Read-Only Memory (EEPROM), a storage drive, an optical disc, and the like. Machine-readable storage medium 404 may be disposed within system 400, as shown in FIG. 4. In this situation, the executable instructions may be “installed” on the system 400. Machine-readable storage medium 404 may be a portable, external or remote storage medium, for example, that allows system 400 to download the instructions from the portable/external/remote storage medium. In this situation, the executable instructions may be part of an “installation package”. As described herein, machine-readable storage medium 404 may be encoded with executable instructions for context aware data backup. The machine-readable storage medium may be non-transitory.

Referring to FIG. 4, pair distribute instructions 406, when executed by a processor (e.g., 402), may cause system 400 to distribute a first set of pairs and a second set of pairs to a plurality of data nodes. Each pair in the first set of pairs may be of a user of a social network and a product on the social network. Each pair in the second set of pairs may define a connection between users on the social network. A first pair from the first set of pairs and a second pair from the second set of pairs may be used as a first input key and a second input key, respectively, for a map function. A first observable factor and a first latent factor may be used as values for the first input key. A second observable factor and a second latent factor are used as values for the second input key.

Probability determine instructions 408, when executed by a processor (e.g., 402), may cause system 400 to determine, on the plurality of data nodes, a probability distribution of a first user's interest in a first product and a relationship between the first user and a second user. The probability may be based on an observable factor and a latent factor. Triplet generate instructions 410, when executed by a processor (e.g., 402), may cause system 400 to generate, based on the probability distribution, a triplet including two users from the social network and an interest product that at least one of the two users has expressed interest in on the social network. Most likely interest and relationship determine instructions 412, when executed by a processor (e.g., 402), may cause system 400 to determine, based on the probability distribution, a most likely interest of the first user and a most likely relationship of the first user. Potential interest and relationship predict instructions 414, when executed by a processor (e.g., 402), may cause system 400 to predict a potential interest of the first user and/or a potential relationship between the first user and another user of the social network based on the most likely interest and the most likely relationship.

The foregoing disclosure describes a number of examples for user interest and relationship determination. The disclosed examples may include systems, devices, computer-readable storage media, and methods for user interest and relationship determination. For purposes of explanation, certain examples are described with reference to the components illustrated in FIGS. 1-4. The functionality of the illustrated components may overlap, however, and may be present in a fewer or greater number of elements and components. Further, all or part of the functionality of illustrated elements may co-exist or be distributed among several geographically dispersed locations. Further, the disclosed examples may be implemented in various environments and are not limited to the illustrated examples.

Further, the sequence of operations described in connection with FIGS. 1-4 are examples and are not intended to be limiting. Additional or fewer operations or combinations of operations may be used or may vary without departing from the scope of the disclosed examples. Furthermore, implementations consistent with the disclosed examples need not perform the sequence of operations in any particular order. Thus, the present disclosure merely sets forth possible examples of implementations, and many variations and modifications may be made to the described examples.

1. A method comprising:
distributing a first set of pairs and a second set of pairs to a plurality of data nodes, wherein each pair in the first set of pairs is of a user of a social network and a product on the social network and each pair in the second set of pairs defines a connection between users on the social network;
calculating, on a first data node belonging to the plurality of data nodes, a first probability of a first user's interest in a first product based on a first observable factor and a first latent factor, wherein the first user and the first product belong to a first pair from the first set of pairs;
calculating, on a second data node, a second probability of a likelihood of a relationship between the first user and a second user, based on a second observable factor and a second latent factor, wherein the first user and the second user belong to a second pair from the second set of pairs;
determining, based on the first probability and the second probability, a most likely interest of the first user and a most likely relationship of the first user; and
predicting a potential interest of the first user based on the most likely interest and the most likely relationship,

2. The method of claim 2 wherein the first pair and the second pair are used as a first input key and a second input key, respectively, for a map function, the first observable factor and the first latent factor are used as values for the first input key and the second observable factor and the second latent factor are used as values for the second input key.

3. The method of claim 2, further comprising
generating, based on the first probability and the second probability, a triplet including two users from the social network and a product that at least one of the two users has expressed interest in on the social network.

4. The method of claim 3, further comprising:
maximizing an objective function corresponding to the triplet, wherein a first parameter of the objective function corresponds to the most likely interest of the first user and a second parameter of the objective function corresponds to the most likely relationship of the first user.

5. The method of claim 4, wherein the objective function is maximized using a stochastic gradient descent.

6. The method of claim 1 further comprising:
determining a probability distribution of the first user's interest in the first product and the relationship between the first user and the second user.

7. The method of claim 6, wherein a user-interest-user triplet is used as an input key for a reduce function and the probability distribution is used as a value for the input key.

8. The method of claim 7, further comprising:
distributing each pair in the first set of pairs and the second pairs to the plurality of data nodes, wherein each data node in the plurality of data nodes processes a pair; and
merging a result of processing by the plurality of data nodes using the triplet as a key so that all values using the same triplet are grouped together.

9. A system comprising:
a first probability calculator to calculate, on a first data node, a first probability of a first user's interest in a first product based on a first observable factor and a first latent factor;
a second probability calculator to calculate, on a second data node, a second probability of a likelihood of a relationship between the first user and a second user based on a second observable factor and a second latent factor;
an interest and relationship determiner to determine, based on the first probability and the second probability, a most likely interest of the first user and a most likely relationship of the first user;
triplet generator to generate, based on the first probability and the second probability, a triplet including two users from the social network and a product that at least one of the two users has expressed interest in on the social network; and
a relationship predictor to predict a potential relationship of the first user based on the most likely interest and the most likely relationship.

10. The system of claim 9 wherein the first user and the first product are used as a first input key and the first user and the second user are used as a second input key for a map function, the first observable factor and the first latent factor are used as values the first input key and the second observable factor and the second latent factor are used as values for the second input key.

11. The system of claim 9 wherein the triplet is used as an input key for a reduce function and a value for the input key is a probability distribution of the first user's interest in the first product and the relationship between the first user and the second user.

12. A non-transitory machine-readable storage medium encoded with instructions, the instructions executable by a processor of a system to cause the system to:
distribute a first set of pairs and a second set of pairs to a plurality of data nodes, wherein each pair in the first set of pairs is of a user of a social network and a product on the social network and each pair in the second set of pairs defines a connection between users on the social network;
determine, on the plurality of data nodes, a probability distribution of a first user's interest in a first product and a relationship between the first user and a second user, wherein the probability is based on an observable factor and a latent factor;
generate, based on the probability distribution, a triplet including two users from the social network and an interest product that at least one of the two users has expressed interest in on the social network;
determine, based on the probability distribution, a most likely interest of the first user and a most likely relationship of the first user; and
predict a potential interest of the first user based on the most likely interest and the most likely relationship.

13. The non-transitory machine-readable storage medium of claim 12 wherein the triplet is used as an input key for a reduce function and the probability distribution is used as a value for the input key.

14. The non-transitory machine-readable storage medium of claim 12, wherein the instructions executable by the processor of the system further cause the system to:
maximize an objective function corresponding to the triplet, wherein a first parameter of the objective function corresponds to the most likely interest of the first user and a second parameter of the objective function corresponds to the most likely relationship of the first user.

15. The non-transitory machine-readable storage medium of claim 12, wherein the instructions executable by the processor of the system further cause the system to:
distribute each pair in the first set of pairs and the second pairs to the plurality of data nodes, wherein each data node in the plurality of data nodes processes a pair; and
merge a result of processing by the plurality of data nodes using the triplet as a key so that all values using the same triplet are grouped together.
